(19) United States
(12) Patent Application Publication
(10) Pub. No.: US 2024/0363014 A1
(43) Pub. Date: Oct. 31, 2024

(54) Automatic Dependent Surveillance Broadcast (ADS-B) Collision Avoidance Method and System for Aircraft that can Exceed the Speed of Sound

(71) Applicant: United States of America as Represented by the Administrator of NASA, Washington, DC (US)

(72) Inventor: Ricardo Alejandro ARTEAGA, Lancaster, CA (US)

(21) Appl. No.: 18/138,938

(22) Filed: Apr. 25, 2023

(51) Int. Cl. G08G 5/04; B64C 30/00; G08G 5/00

(52) U.S. Cl. CPC G08G 5/045; G08G 5/0004; B64C 30/00

(57) ABSTRACT

An ADS-B collision avoidance method and system are provided for aircraft having a speed profile that includes supersonic speeds. ADS-B messages are transmitted from an aircraft at a transmission rate and power predicated on the aircraft's speed. A trained neural network predicts a time-based trajectory of the aircraft using the position, altitude, and velocity of the aircraft when it is flying supersonic. Time-based zone boundaries are generated using the time-based trajectory. Each time-based zone boundary is disposed about the aircraft flying supersonic. Each time-based zone boundary is indicative of an amount of time for the aircraft to travel thereto along the time-based trajectory. Each time an aerial vehicle crosses one of the time-based zone boundaries when the aircraft is flying supersonic, at least one of an indication of the presence of the aerial vehicle, an indication of a potential collision, and a maneuver to avoid the potential collision are generated.

### ORIGIN OF THE INVENTION

The invention described herein was made by an employee of the United States Government and may be manufactured and used by or for the Government of the United States of America for governmental purposes without the payment of any royalties thereon or therefor.

### BACKGROUND OF THE INVENTION

### 1. Field of the Invention

This invention relates to automatic dependent surveillance broadcast (ADS-B) collision avoidance methods and systems. More specifically, the invention is an ADS-B method and system for use by aircraft having a speed profile that includes supersonic speeds.

### 2. Description of the Related Art

ADS-B is a novel technology that will improve air traffic safety and efficiency. In general, ADS-B technology uses highly accurate global positioning system (GPS) signals to provide an aircraft with the capability to automatically broadcast “ownship” information and automatically track/surveil other aerial vehicles to ultimately avoid/prevent mid-air collisions. Accordingly, the Federal Aviation Administration (FAA) has mandated that aircraft operating within certain airspaces of the national airspace (NAS) be equipped with “ADS-B Out” technology to broadcast “ownship” information for receipt by “ADS-B In” receivers onboard other aerial vehicles.

Existing Federal Aviation Regulations, procedures, and technologies provide for routine access to the NAS for subsonic aircraft. The standard state-of-the art for ADS-B Out is only effective at subsonic to transonic speeds, reduced altitudes, and lower aircraft gravitational accelerations of less than 4G for the following reasons. Civilian (non-military) GPS receiver performance is restricted by the International Traffic in Arms Regulations (ITAR). Thus, if the GPS receiver on an aircraft is higher than 60,000 feet above mean sea level and/or is traveling faster than 1000 knots, the GPS unit will not output data. Further, if a civilian GPS receiver exceeds a gravitational acceleration of 4G, the GPS unit will not output messages. Since ADS-B is highly dependent on GPS data, current ADS-B transponders would not broadcast surveillance data if a commercial supersonic vehicle exceeds the above-specified altitudes, speeds, or gravitational accelerations. In addition, existing Federal Aviation Regulations for manned aircraft see-and-avoid risk mitigation standards are not safe or effective for the visual acquisition of aircraft flying at supersonic speeds.

Conventional ADS-B Out schemes are designed for vehicle speeds that are below or near the speed of sound. For example, U.S. Pat. Nos. 9,405,005 and 10,302,759 disclose ADS-B systems for manned or unmanned aircraft that provide ownship and traffic situational awareness for aircraft operating with a subsonic speed profile. However, once an aircraft's speed exceeds the speed of sound, the distance the aircraft travels during the latency period between position reports significantly exceeds the position accuracy of current ADS-B systems. Therefore, current certified ADS-B methods and systems are not designed for the performance or latency requirements associated with the more challenging supersonic and hypersonic speed regimes.

### SUMMARY OF THE INVENTION

Accordingly, it is an object of the present invention to provide an ADS-B method and system for manned or unmanned aircraft having a speed profile capability that includes subsonic to hypersonic speeds to achieve situational awareness and collision avoidance throughout the speed profile.

Another object of the present invention is to provide an ADS-B method and system for supersonic and hypersonic aircraft that includes a collision avoidance function.

Other objects and advantages of the present invention will become more obvious hereinafter in the specification and drawings.

In accordance with the present invention, an automatic dependent surveillance broadcast (ADS-B) collision avoidance method and system for use by aircraft having a speed profile that includes supersonic speeds is provided. ADS-B messages are transmitted from an aircraft at a transmission rate and a transmission power predicated on a speed of the aircraft. The ADS-B messages include position, altitude, and velocity of the aircraft. Using a trained neural network, a time-based trajectory of the aircraft is predicted using the position, altitude, and velocity of the aircraft when the aircraft is flying supersonic. Time-based zone boundaries are generated using the time-based trajectory. Each time-based zone boundary is disposed about the aircraft when the aircraft is flying supersonic. Each time-based zone boundary is indicative of an amount of time for the aircraft to travel thereto along the time-based trajectory. Each time an aerial vehicle is predicted to cross or crosses one of the time-based zone boundaries when the aircraft is flying supersonic, at least one of an indication of the presence of the aerial vehicle, an indication of a potential collision between the aircraft and the aerial vehicle, and a maneuver to avoid the potential collision between the aircraft and the aerial vehicle are generated.

### BRIEF DESCRIPTION OF THE DRAWING(S)

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of an ADS-B Out, ADS-B In, and collision avoidance system for an aircraft whose speed profile includes supersonic speeds in accordance with an embodiment of the present invention;

FIG. 2 is a schematic view of an aircraft flying supersonic with four generated time-based zone boundaries disposed thereabout in accordance with an embodiment of the present invention;

FIG. 3 is a top-level schematic of a neural network architecture used to predict a time-based trajectory of an aircraft when the aircraft is flying supersonic in accordance with an embodiment of the present invention; and

FIG. 4 is a schematic view of an aircraft flying subsonic with four generated distance-based zone boundaries disposed thereabout in accordance with an embodiment of the present invention.

### DESCRIPTION OF THE PREFERRED EMBODIMENT(S)

The present invention provides a new ADS-B collision avoidance methodology and system for aircraft that can exceed the speed of sound. The new methodology is implemented using a number of system elements onboard an aircraft. Depending on the type of aircraft, some of the system elements can already exist onboard the aircraft, some of the system elements can require modification of existing aircraft hardware, and/or some of the system elements can comprise new hardware and software. Accordingly, it is to be understood that the ADS-B methods described herein could be implemented by a variety of systems without departing from the scope of the present invention.

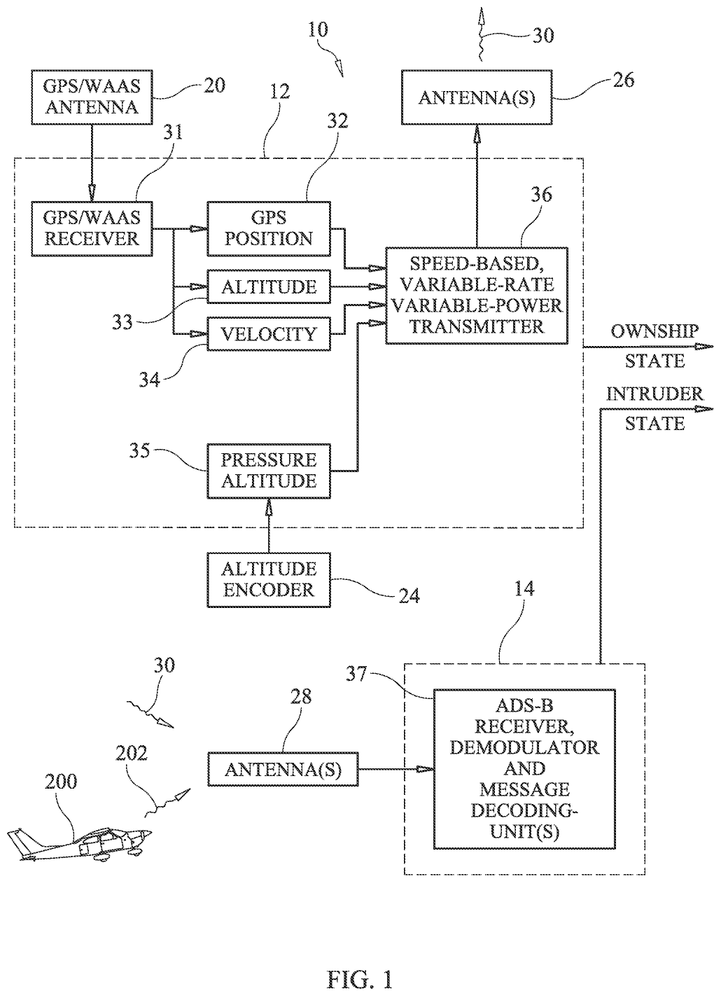

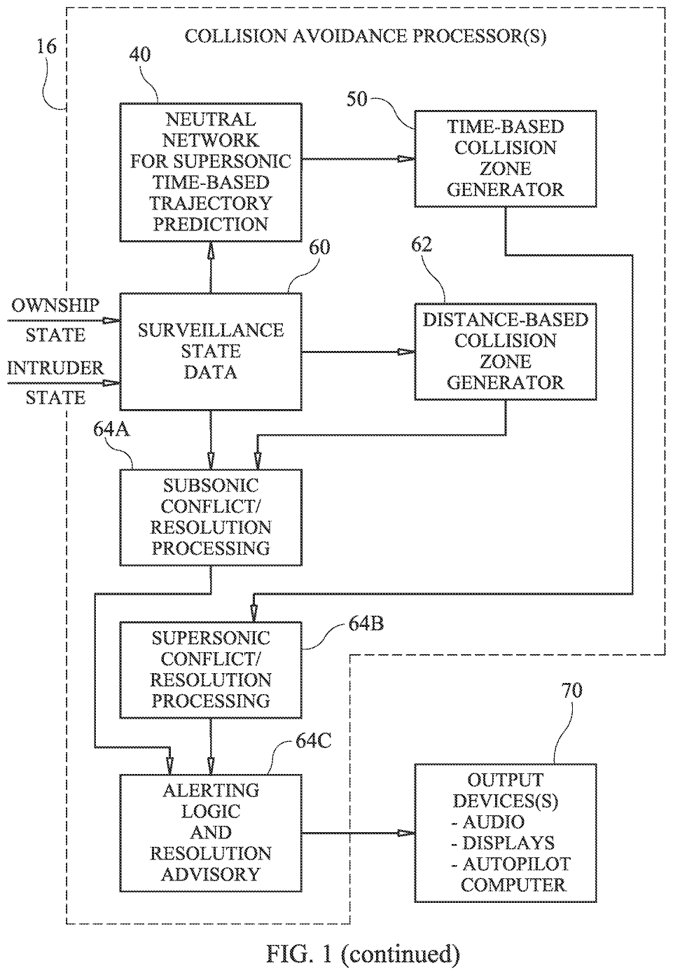

Referring now to the drawings and more particularly to FIG. 1, a schematic view of an ADS-B Out, ADS-B In, and collision avoidance system installed on an aircraft whose speed capabilities or profile includes supersonic speeds in accordance with an embodiment of the present invention is shown and is referenced generally by numeral 10. System 10 includes an ADS-B Out portion 12, an ADS-B In portion 14, and a collision avoidance processor(s) 16, as will be described further below. System 10 can be installed on any military, private, or commercial aircraft (not shown) that can fly supersonic. As used herein, the term “supersonic” includes any speed that is greater than the speed of sound (i.e., Mach 1) and, therefore, includes the hypersonic regime (i.e., speeds that are generally between Mach 5 and Mach 10).

Since supersonic aircraft generally spend some flight time in the subsonic flight regime, system 10 is also equipped to support subsonic ADS-B Out and ADS-B In processing. By way of example, subsonic ADS-B Out and subsonic ADS-B In processing can be implemented by system 10 as disclosed in U.S. Pat. Nos. 9,405,005 and 10,302,759, the contents of which are hereby incorporated by reference. Accordingly, subsonic ADS-B Out and subsonic ADS-B In processing will only be described briefly herein as the novel features of the present invention lie in the enhancements that augment subsonic ADS-B collision avoidance for an aircraft that is flying supersonic.

In terms of ADS-B Out portion 12, the present invention outputs or transmits ADS-B Out messages at a transmission rate and transmission power that is predicated on the speed of the aircraft on which system 10 is installed. When the aircraft is flying subsonic, the transmission rate is 2 hertz (Hz). However, to meet Federal regulations when the aircraft flies supersonic, the present invention automatically changes the transmission rate and transmission power of the ADS-B Out messages to account for the increased estimated position uncertainty (EPU) associated with supersonic flight, i.e., the extra distance that an aircraft travels at supersonic speed as opposed to the distance it travels at subsonic speeds during the latency period between ADS-B broadcast transmissions. The operational safety object of the collision avoidance system and enhanced ADS-B surveillance is to detect aircraft closing at supersonic speeds in time to alert the pilot of a collision.

In accordance with an embodiment of the present invention, the transmission rate (in Hertz or Hz) and power (in watts or W) of ADS-B messages can be varied as set forth in the table below. The transmission power dictates the surveillance range (in nautical miles or NM) of the ADS-B Out messages with a 90% detection reliability within the surveillance range.

| | Transmission | | | Power and | |
|---|---|---|---|---|---|
| Mach Speed | Rate | | EPU | Surveillance Range | |
| <Mach 1.5 | 2 | Hz | <304 ft | 125 W | 148 NM |
| <900 knots | | | | (50.97 dbm) | |
| Mach 1.5-Mach 3 | 5-10 | Hz | <303 ft | 250 W | 184 NM |
| >900-1800 knots | | | | (53.98 dbm) | |
| Mach 3-Mach 6 | 20 | Hz | <303 ft | 500 W | 260 NM |
| >1800-3600 knots | | | | (56.99 dbm) | |
| Mach 6-Mach 10 | 50 | Hz | <192 ft | >1000 W | 368 NM |
| >3600-5700 knots | | | | (60 dbm) | |

It is to be understood that the transmission rates and transmission powers for supersonic flight could be different (e.g., in terms of rates/powers, increments thereof, etc.) than those shown in the above table without departing from the scope of the present invention.

For purposes of the present invention, each ADS-B Out message transmitted by ADS-B Out portion 12 of system 10 includes “ownship” position (i.e., latitude and longitude), altitude, and velocity. Typically, an ADS-B Out message will also include the aircraft's unique identity per Federal regulations. ADS-B is a complex system dependent on an aircraft's existing external systems, including navigation, communication, and displays. In the illustrated embodiment, a GPS/Wide Area Augmentation System (GPS/WAAS) antenna 20 is directly connected to an ADS-B GPS/WAAS receiver 31. This enables the system to derive accurate ownship GPS position 32, altitude 33, and velocity 34 state information. It is assumed herein that each aircraft implementing the present invention is equipped with appropriate altimetry systems and/or an altitude encoder 24 to derive accurate ownship barometric pressure altitude 35 for operations to at least 60,000 feet or FL600. Accordingly, ownship position 32, altitude 33, velocity 34, and barometric pressure altitude 35 are provided to a transmitter 36 that “encodes” this data in an ADS-B Out message format in accordance with ways understood in the art. Transmitter 36 is configured to generate ADS-B Out messages at a transmission rate and transmission power predicated on the speed of the aircraft indicated by velocity 34. An exemplary rate and power schedule is set forth in the table above. Transmitter 36 provides the ADS-B Out messages to one or more of aircraft-mounted antenna(s) 26 at the speed-profile transmission rate and power level. The transmitted ADS-B Out messages emanating from antenna(s) 26 are referenced by numeral 30. Transmission of the ADS-B Out messages 30 can occur at one or more frequencies (e.g., 978 MHz and/or 1090 MHz), as is known in the art.

The present invention uses short-term time-based flight trajectory predictions to support an aircraft's alert/awareness and collision avoidance when the aircraft is flying supersonic. Referring again to FIG. 1, a trained neural network 40 is provided with ownship state from ADS-B In portion 14 (i.e., GPS position, altitude, and velocity) when the aircraft is flying supersonic. Neural network 40 then generates a prediction for the aircraft's 4-D trajectory (i.e., 3-D positions at points in time) at relatively short time intervals in the future relative to the current time (e.g., 15 seconds, 30 seconds, 60 seconds, 90 seconds from the current time). The neural network's time-based trajectory prediction is provided to a time-based collision zone generator 50 (i.e., a processor) whose generated 4-D trajectory predictions are critical for the detection of conflicts in the future. A Closest Point of Approach (CPA) is used with the predictions for collision avoidance.

In general, collision zone generator 50 uses the time-based trajectory prediction to generate a plurality of time-based zone boundaries at the time intervals of the trajectory prediction. The shortest time interval (e.g., 15 seconds) is used to define a three-dimensional zone centered on the aircraft, since another aerial vehicle could overtake the aircraft from behind during this time interval. A conflict detection algorithm resident in a collision avoidance processor 16 determines future ownship collision volume penetration based on the current airspace surveillance state data 60 based on ownship state data from ADS-B Out portion 12 and intruder state data from ADS-B In portion 14. A detected and/or predicted crossing (penetration) of the outer boundary of the shortest-time-interval collision avoidance zone by another aerial vehicle approaching from any direction triggers the most immediate collision-avoidance maneuvers for the aircraft as will be explained further below.

Collision zone generator 50 implements a different approach for the longer time intervals (e.g., 30, 60 and 90 seconds into the future) in the en-route airspace where an overtake from behind the aircraft is generally not a concern. The operation logic herein balances the necessary protection and unnecessary traffic advisories. More specifically, since the aircraft's closure rate is greatest if it maintains a straight-line heading, a collision zone's boundary is furthest away along the aircraft's straight-line heading when the aircraft is flying supersonic. In air space regions that are forward of the aircraft and offset from the aircraft's straight-line heading (i.e., also referred to as “off axis”), the presence of another aerial vehicle is less relevant unless/until it converges closer to the aircraft's straight-line heading. In other words, collision zone boundaries for an aircraft flying supersonic are elongate shapes for the longer time intervals where each elongate shape's major axis is aligned with the trajectory prediction's straight-line heading.

In some embodiments of the present invention, an exemplary supervised trained neural network's predicted flight trajectory's points are converted from a global coordinate frame (e.g., WGS84) to the aircraft's local XYZ coordinate frame so that the major axes of the time-based collision zones are oriented with respect the aircraft's longitudinal axis.

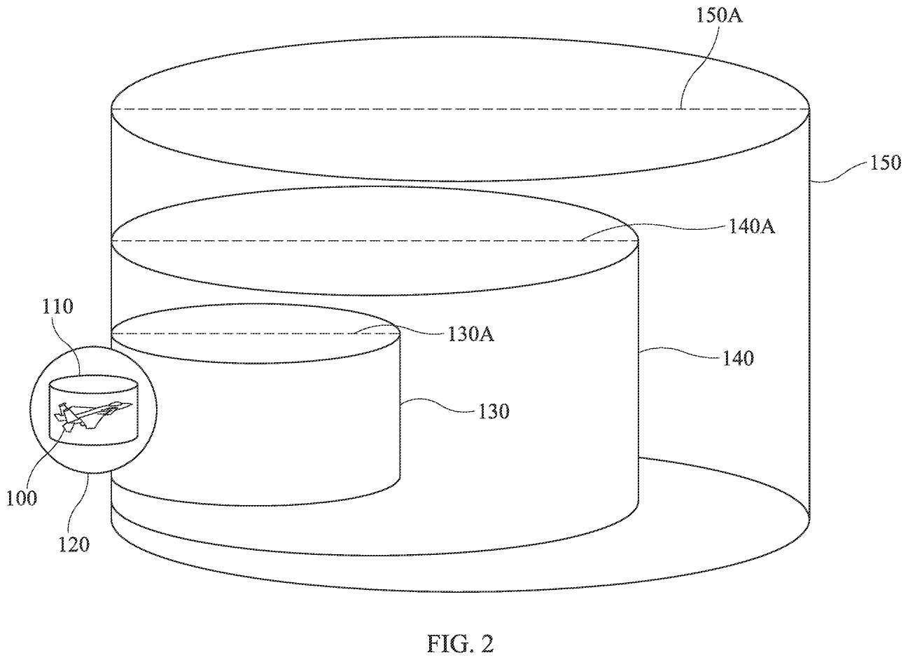

By way of an illustrative example and with reference to FIG. 2, a supersonic-flying aircraft 100 implementing the ADS-B collision avoidance method and system of the present invention is illustrated with a fixed-size collision boundary zone 110 and four time-based zone boundaries 120, 130, 140, and 150 disposed about aircraft 100. The innermost zone boundary 110 remains fixed in size at all times and can be based on the dimensions of aircraft 100, e.g., a radius of 500 ft and a height of +100 ft or based on aircraft dimensions. In all cases, aircraft 100 is centered in zone 110, as illustrated. Each time-based zone boundary encloses a three-dimensional volume extending above and below aircraft 100. The innermost time-based zone boundary 120 associated with the shortest time interval (e.g., 15 seconds) is spherical and has aircraft 100 centered therein, as illustrated. For each of the longer time intervals, an axial cross-section of each such volume is generally an elongate shape (e.g., ellipse, oval, etc.) whose major axis 130A/140A/150A originates with aircraft 100, extends forward therefrom, and is aligned with the predicted straight-line trajectory of aircraft 100 as it flies supersonic. In the illustrated embodiment, zone boundary 120 centered on aircraft 100 defines the boundary of a collision zone associated with the shortest time interval (e.g., 15 seconds) of the trajectory prediction, zone boundary 130 defines the boundary of a collision zone associated with the second time interval (e.g., 30 seconds) of the trajectory prediction, zone boundary 140 defines the boundary of a collision zone associated with the third time interval (e.g., 60 seconds) of the trajectory prediction, and zone boundary 150 defines the boundary of a collision zone associated with the fourth time interval (e.g., 90 seconds) of the trajectory prediction.

Each of the above-described collision zone boundaries defines an alerting threshold for aerial vehicle encounters that is time-based. In some embodiments of the present invention, the time-based zone boundaries are defined by the elongate-shaped collision zones generated at zone generator 50 (e.g., the zones defined by boundaries 120, 130, 140, and 150). The three elongated shape protection volumes (zones) span out to the surveillance range (speed-power profile) to account for the higher closure rates and can be generated in accordance with the following ellipsoid or ovoid equation:

$$\frac{{x}^{2}}{{a}^{2}} + \frac{{y}^{2}}{{b}^{2}} = 1$$

Where “a” is the ellipsoid parameter in the major axis computed in nautical miles from one of its trajectory points P in the future (e.g., 30, 60, and 90 seconds in the illustrated example) as computed by neural network 40, b=a/2 is the ellipsoid parameter in the minor axis in nautical miles, and the “x” values and “y” values for the collision zones are computed around the aircraft “F1 ellipse foci” in the longitudinal major axis and lateral minor axis, from the predicted points. The predicted flight trajectory points (i.e., latitude, longitude, altitude) are converted from a global coordinate frame (e.g., WGS84) to the aircraft's local XYZ coordinate frame to compute “a” and “b” so that the major axes of the time-based collision zones are oriented with respect the aircraft's longitudinal (x) and lateral (y) axis. It is to be understood that the collision zone boundaries defined by the directional scaling parameters a and b of the ellipsoid for supersonic flight could be different (e.g., changed to future FAA regulations parameters thereof, etc.) than those shown in the above without departing from the scope of the present invention.

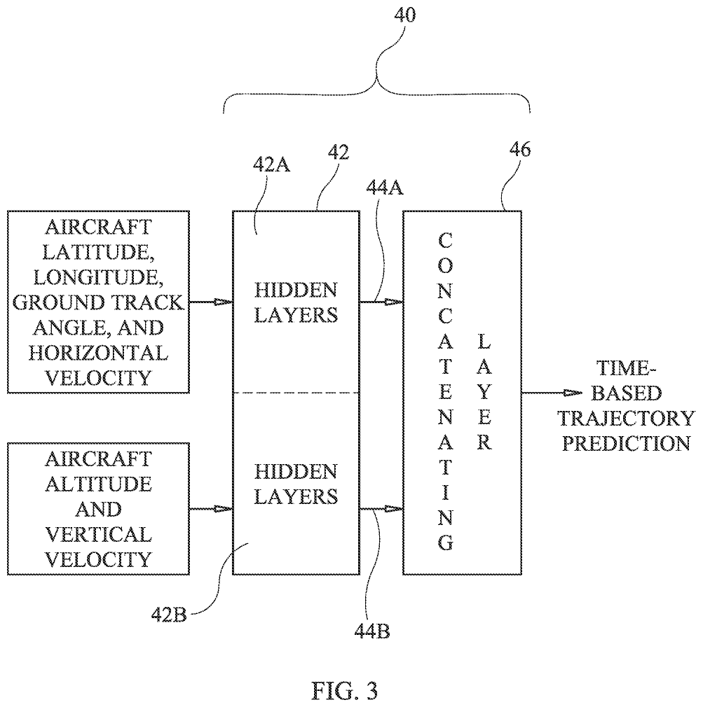

As mentioned above, trained neural network 40 generates the time-based trajectory prediction in terms of time, space, and position in the future in order to generate the above-described collision zones when an aircraft is flying supersonic. Referring additionally now to FIG. 3, a top-level schematic view of neural network 40 is shown to describe the structure of the neural network in accordance with an embodiment of the present invention. As is well-known in the art of neural network architecture, neural network 40 includes hidden layers 42. In terms of the present invention, separate processing paths 42A and 42B are defined within hidden layers 42. More specifically, the aircraft's latitude, longitude, ground track angle, and horizontal velocity vectors are processed along path 42A, while the aircraft's altitude and vertical velocity vectors are processed along path 42B. The separate processing paths of the aerodynamic axis data in neural network 40 allows the network processing to be efficiently integrated with graphics processing used by collision zone generator 50 for generation of images that are to be displayed on one or more output devices (not shown in FIG. 3). The results 44A from path 42A are concatenated at layer 46 with the results 44B from path 42B to form the time-based trajectory prediction output from neural network 40.

Referring again to FIG. 1, the ADS-B In portion 14 of system 10 receives inputs from signals detected at one or more aircraft-mounted antenna(s) 28. The detected signals are provided to an ADS-B receiver, demodulator, and message decoding unit(s) 37 having electronic circuitry capable of receiving ADS-B signals at the standard/subsonic 2 Hz transmission rate and the higher rates up to 50 Hz. In general, unit(s) 37 receive and process ADS-B Out messages 202 emanating from an aerial vehicle 200. In some embodiments of the present invention, the ownship aircraft generated ADS-B Out message 30 can also be detected by ADS-B In portion 14 for redundancy. Unit(s) 37 typically demodulate and decode the ADS-B messages for further processing as would be well-understood in the art.

Antenna(s) 28 and unit(s) 37 can be configured to receive ADS-B messages on the 978 MHz frequency and/or the 1090 MHz frequency as is known in the art. Antenna(s) 28 and unit(s) 37 can additionally be configured to receive ground-based messages such as Traffic Information Services-Broadcast (TIS-B) messages. In some embodiments of the present invention, an ADS-B transceiver and/or transponder can be configured to exchange information (e.g., position, velocity, trajectory intent, and aircraft identification) directly through a data link on the 978 MHz frequency and/or the 1090 MHz frequency as is known in the art. Messages 202 detected by antenna(s) 28 are provided to unit(s) 37 for “message decoding” as needed for the interface output to collision avoidance processor(s) 16. It is to be understood that the configuration and/or relationship between unit(s) 37 and processor(s) 16 (e.g., separate, combined, etc.) can be realized in a variety of ways without departing from the scope of the present invention. Processor(s) 16 are programmed to carry out several collision avoidance functions in order to implement the method of the present invention, as will be explained further below. The functions of the above-described generator 50 and those provided by the present invention's conflict/resolution processing can be carried out in separate processors or the same processor without departing from the scope of the present invention.

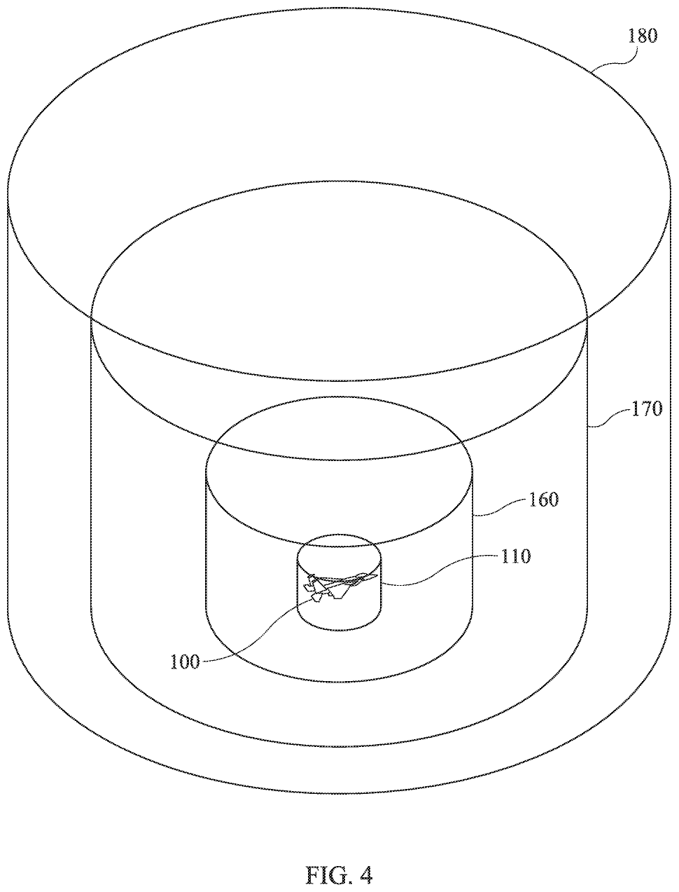

In accordance with an embodiment of the present invention, collision avoidance processor(s) 16 and its processing algorithms are capable of processing ADS-B messages 202 when the ownship aircraft is flying subsonic and when it is flying supersonic. When the aircraft is flying subsonic, ownship velocity 34 provided to processor 16 triggers subsonic conflict/resolution processing 64A that can be implemented as described in the afore-referenced U.S. Pat. Nos. 9,405,005 and 10,302,759. Briefly and with additional reference to FIG. 4, subsonic conflict/resolution processing 64A uses the distance-based collision zones generated at distance-based collision zone generator 62 where the collision zone sizes are predetermined as described in the afore-referenced patents. The zones are disposed about aircraft 100 that is flying subsonic. Each zone's size is indicative of the collision threat risk associated therewith, where the smallest zone 110 indicates the greatest level of threat risk and is configured as described previously herein. In the illustrated example, three additional cylindrical zones 160, 170, and 180 are illustrated. Each of zones 160, 170, and 180 is a cylindrical volume whose boundary's axial cross section is circular.

In some embodiments of the present invention, the radius of zone 160 is 1 nautical mile, the radius of zone 170 is 3 nautical miles, and the radius of zone 180 is 5 nautical miles. The radius and size of the cylindrical protection volumes (zones) or times to CPA can be based on FAA separation standards, as is understood in the art. As explained in the above-referenced patents, subsonic conflict/resolution processing 64A determines if the detected presence of aerial vehicle 200 (i.e., when ADS-B messages 202 are detected) warrants the generation of one or more of the following exemplary alerts/resolutions at an alert and resolution generator 64C:
a general traffic (intruder) alert when aerial vehicle 200 is detected within distance-based zone boundary 180;
a potential collision (threat) alert when aerial vehicle 200 is detected within a closer distance-based zone boundary (e.g., zone boundary 170); and
a resolution advisory that directs/controls an immediate (and typically drastic) flight maneuver to avoid a collision with aerial vehicle 200 when the intruder aircraft is predicted to penetrate (closest point of approach) or crosses zone boundary 160 and/or fixed collision volume 110.
   The parameters governing the schedule of alert(s) and/or resolution advisory can be different from that described above without departing from the scope of the present invention. The alert(s) and/or resolution advisory are provided to one or more output device(s) 70 such as, but not limited to, audio devices that produce an audible alert/announcement, displays resident in the aircraft's cockpit or on portable devices that produce visual situational awareness, autopilot computers for automatic/immediate execution of a resolution advisory, etc.

As mentioned above, the ADS-B omnidirectional surveillance range is significantly increased for safety to provide detection with sufficient time so that the collision avoidance algorithms can function at high aircraft closure rates. When the aircraft is flying supersonic, as evidenced by ownship velocity 34 provided to the collision avoidance processor(s) 16, supersonic conflict/resolution processing 64B is triggered. Similar to subsonic processing 64A, supersonic processing 64B determines if aerial vehicle 200 has been detected and if it has crossed one of the time-based zone boundaries (e.g., zone boundaries 120, 130, 140, and 150 illustrated in FIG. 2) generated by collision zone generator 50. Once a detection and/or boundary crossing occurs, alert and resolution advisory generator 64C provides one or more of a general traffic alert, a potential collision alert, and a resolution advisory to output device(s) 70. That is, supersonic processing 64B determines if the detected presence of aerial vehicle 200 (i.e., when ADS-B messages 202 are detected) warrants the generation of one or more alerts/resolutions at an alert and resolution generator 64C in accordance with the following exemplary, but not limiting, alert and resolution schedule:
a general traffic (intruder) alert when aerial vehicle 200 is detected crossing or within an outer one of time-based zone boundaries 140 or 150;
a potential collision (threat) alert when aerial vehicle 200 is detected crossing or within one of the inner time-based boundaries (e.g., zone boundary 130);
a resolution advisory that directs/controls a flight maneuver to avoid a collision with aerial vehicle 200 when aerial vehicle 200 is predicated to penetrate (e.g., using CPA) and/or cross one of the inner time-based zone boundaries (e.g., zone boundary 130); and
a resolution advisory that directs/controls an immediate (and typically drastic) flight maneuver to avoid a collision with aerial vehicle 200 when aerial vehicle 200 is predicted to penetrate (e.g., using CPA) and/or cross innermost zone boundary 120 and/or fixed collision volume 110.

In some embodiments of the present invention, a conflict detection algorithm resident in processor(s) 16 can be used to determine future ownship collision volume penetration based on the current airspace surveillance state data 60. When included in the present invention, the conflict resolution algorithm can be used to modify the ownship trajectory once the conflict detection algorithm detects the loss of separation (e.g., zone boundary 130) and can issue a corrective resolution advisory to provide increased separation.

The above-described supersonic-flight alert(s) and/or resolution advisor(ies) are provided to one or more output device(s) 70 such as, but not limited to, audio devices, cockpit displays, autopilot computers, etc. For example, a resolution advisory can be sent to the aircraft's existing autopilot for autonomous maneuver execution with an independent means to disengage the autopilot system. In some embodiments of the present invention, it may be advantageous to have a display tablet available for pilot viewing where the display tablet is configured to track cooperative intruders and display targets as disclosed herein.

In some embodiments of the present invention, the trained neural network can use the defined time-based collision zones boundaries to detect conflicts. In such cases, trained neural network 40 computes ownship 4-D trajectory predictions and another intruder neural network (not shown) computes intruder 4-D trajectory predictions for each aircraft to detect conflicts with ownship in pair-wise terms. Surveillance state data is used to compute intruder 4-D trajectory predictions for each aircraft comprising of latitudes, longitudes, altitudes, times, and predicted conflict flag true or false, etc., within the collision zones generated by collision zone generator 50. Conflicts are validated by conflict/resolution processing 64B to determine whether a conflict (i.e., potential collision) is true or not.

The advantages of the present invention are numerous. The ADS-B collision avoidance method and system described herein will allow supersonic-capable aircraft to operate safely in the NAS using ADS-B throughout their entire speed profile. The supersonic-regime's time-based trajectory prediction and time-based collision zone generation allow the method to safely adapt to the highest-closure rates associated with supersonic flight to prevent mid-air collisions.

Successful tests of the present invention were carried out using a prototype ADS-B 1090ES transmitter configured as described herein for operation at supersonic speeds on two F-18B aircraft. During test flights of the aircraft at supersonic speeds (e.g., Mach˜1.41), the present invention produced alerts and advisories that met the FAA regulatory compliance for all test flights. The ADS-B collision avoidance system was validated ultimately through live flight testing with a commanded maneuver, e.g., a resolution advisory “Turn Right” and visual/aural collision alerting to a real aerial vehicle intruder to prevent a mid-air collision.

Although the invention has been described relative to specific embodiments thereof, there are numerous variations and modifications that will be readily apparent to those skilled in the art in light of the above teachings. It is therefore to be understood that, within the scope of the appended claims, the invention may be practiced other than as specifically described.

What is claimed as new and desired to be secured by Letters Patent of the United States is:

1. An automatic dependent surveillance broadcast (ADS-B) collision avoidance method for use by aircraft having a speed profile that includes supersonic speeds, said method comprising the steps of:
transmitting, from an aircraft, ADS-B messages at a transmission rate and a transmission power predicated on a speed of the aircraft, said ADS-B messages including position, altitude, and velocity of the aircraft;
predicting, using a trained neural network, a time-based trajectory of the aircraft using said position, said altitude, and said velocity of the aircraft when the aircraft is flying supersonic;
generating a plurality of time-based zone boundaries using said time-based trajectory, each of said time-based zone boundaries disposed about the aircraft when the aircraft is flying supersonic, each of said time-based zone boundaries being indicative of an amount of time for the aircraft to travel thereto along said time-based trajectory; and
generating, each time an aerial vehicle crosses one of said time-based zone boundaries when the aircraft is flying supersonic, at least one of an indication of the presence of the aerial vehicle, an indication of a potential collision between the aircraft and the aerial vehicle, and a maneuver to avoid the potential collision between the aircraft and the aerial vehicle.

2. An ADS-B collision avoidance method according to claim 1, wherein said transmission rate is in a range of 2 Hz to 50 Hz.

3. An ADS-B collision avoidance method according to claim 1, wherein said transmission power is greater than 125 Watts when the aircraft is flying supersonic.

4. An ADS-B collision avoidance method according to claim 1, wherein a portion of said time-based zone boundaries have an axial cross-section defined by an elongate shape having a major axis aligned with said time-based trajectory of the aircraft.

5. An ADS-B collision avoidance method according to claim 4, wherein said elongate shape is selected from the group consisting of ovals and ellipses.

6. An ADS-B collision avoidance method according to claim 1, wherein said position of the aircraft comprises a latitude position of the aircraft and a longitude position of the aircraft, wherein said velocity of the aircraft comprises a horizontal velocity vector and a vertical velocity vector, and wherein said step of predicting comprises the steps of:
processing, along a first processing path of the trained neural network, said position of the aircraft with said horizontal velocity vector to generate first results;
processing, along a second processing path of the trained neural network, said altitude of the aircraft with said vertical velocity vector to generate second results; and
concatenating said first results and said second results.

7. An ADS-B collision avoidance method according to claim 1, further comprising the steps of:
generating a plurality of distance-based zone boundaries when the aircraft is flying subsonic, each of said distance-based zone boundaries disposed about the aircraft; and
generating, each time an aerial vehicle crosses one of said distance-based zone boundaries when the aircraft is flying subsonic, at least one of an indication of the presence of the aerial vehicle, an indication of a potential collision between the aircraft and the aerial vehicle, and a maneuver to avoid the potential collision between the aircraft and the aerial vehicle.

8. An ADS-B collision avoidance method according to claim 7, wherein each of said distance-based zone boundaries has an axial cross-section that is circular.

9. An automatic dependent surveillance broadcast (ADS-B) collision avoidance method for use by aircraft having a speed profile that includes subsonic speeds and supersonic speeds, said method comprising the steps of:
transmitting, from an aircraft, ADS-B messages at one of a plurality of transmission rates and transmission powers predicated on a speed of the aircraft, said ADS-B messages including position, altitude, and velocity of the aircraft;
generating, when the aircraft is flying subsonic, a plurality of concentric distance-based zone boundaries disposed about the aircraft;
generating, each time an aerial vehicle crosses one of said concentric distance-based zone boundaries when the aircraft is flying subsonic, at least one of an indication of the presence of the aerial vehicle, an indication of a potential collision between the aircraft and the aerial vehicle, and a maneuver to avoid the potential collision between the aircraft and the aerial vehicle;
predicting, using a trained neural network when the aircraft is flying supersonic, a time-based trajectory of the aircraft using said position, said altitude, and said velocity of the aircraft;
generating, when the aircraft is flying supersonic, a plurality of time-based zone boundaries using said time-based trajectory, each of said time-based zone boundaries disposed about the aircraft, each of said time-based zone boundaries being indicative of an amount of time for the aircraft to travel thereto along said time-based trajectory; and
generating, each time an aerial vehicle crosses one of said time-based zones when the aircraft is flying supersonic, at least one of an indication of the presence of the aerial vehicle, an indication of a potential collision between the aircraft and the aerial vehicle, and a maneuver to avoid the potential collision between the aircraft and the aerial vehicle.

10. An ADS-B collision avoidance method according to claim 9, wherein said transmission rates are selected from the group consisting of rates in a range of 2 Hz to 50 Hz, and wherein said transmission power is greater than 125 Watts when the aircraft is flying supersonic.

11. An ADS-B collision avoidance method according to claim 9, wherein a portion of said time-based zone boundaries have an axial cross-section defined by an elongate shape having a major axis aligned with said time-based trajectory of the aircraft.

12. An ADS-B collision avoidance method according to claim 11, wherein said elongate shape is selected from the group consisting of ovals and ellipses.

13. An ADS-B collision avoidance method according to claim 9, wherein said position of the aircraft comprises a latitude position of the aircraft and a longitude position of the aircraft, wherein said velocity of the aircraft comprises a horizontal velocity vector and a vertical velocity vector, and wherein said step of predicting comprises the steps of:
processing, along a first processing path of the trained neural network, said position of the aircraft with said horizontal velocity vector to generate first results;
processing, along a second processing path of the trained neural network, said altitude of the aircraft with said vertical velocity vector to generate second results; and
concatenating, using the neural network, said first results and said second results.

14. An ADS-B collision avoidance method according to claim 9, wherein each of said distance-based zone boundaries has an axial cross-section that is circular.

15. An automatic dependent surveillance broadcast (ADS-B) collision avoidance method for use by aircraft having a speed profile that includes subsonic speeds and supersonic speeds, said method comprising the steps of:
generating, from an aircraft, ADS-B messages that include position, altitude, and velocity of the aircraft;
transmitting, from the aircraft, said ADS-B messages at a transmission rate and a transmission power that are automatically adjusted predicated on a speed of the aircraft, wherein said transmission rate is 2 Hz when the aircraft is flying subsonic, wherein said transmission rate is greater than 2 Hz when the aircraft is flying supersonic, and wherein said transmission power is at least 125 Watts when the aircraft is flying supersonic;
generating, when the aircraft is flying subsonic, a plurality of concentric distance-based zone boundaries disposed about the aircraft;
generating, each time an aerial vehicle crosses one of said concentric distance-based zone boundaries when the aircraft is flying subsonic, at least one of an indication of the presence of the aerial vehicle, an indication of a potential collision between the aircraft and the aerial vehicle, and a maneuver to avoid the potential collision between the aircraft and the aerial vehicle;
predicting, using a trained neural network when the aircraft is flying supersonic, a time-based trajectory of the aircraft using said position, said altitude, and said velocity of the aircraft;
generating, when the aircraft is flying supersonic, a plurality of time-based zone boundaries using said time-based trajectory, each of said time-based zone boundaries disposed about the aircraft, each of said time-based zone boundaries being indicative of an amount of time for the aircraft to travel thereto along said time-based trajectory; and
generating, each time an aerial vehicle crosses one of said time-based zones when the aircraft is flying supersonic, at least one of an indication of the presence of the aerial vehicle, an indication of a potential collision between the aircraft and the aerial vehicle, and a maneuver to avoid the potential collision between the aircraft and the aerial vehicle.

16. An ADS-B collision avoidance method according to claim 15, wherein said transmission rate is in a range of 10 Hz to 50 Hz when the aircraft is flying supersonic.

17. An ADS-B collision avoidance method according to claim 15, wherein a portion of said time-based zone boundaries have an axial cross-section defined by an elongate shape having a major axis aligned with said time-based trajectory of the aircraft.

18. An ADS-B collision avoidance method according to claim 17, wherein said elongate shape is selected from the group consisting of ovals and ellipses.

19. An ADS-B collision avoidance method according to claim 15, wherein said position of the aircraft comprises a latitude position of the aircraft and a longitude position of the aircraft, wherein said velocity of the aircraft comprises a horizontal velocity vector and a vertical velocity vector, and wherein said step of predicting comprises the steps of:
processing, along a first processing path of the trained neural network, said position of the aircraft with said horizontal velocity vector to generate first results;
processing, along a second processing path of the trained neural network, said altitude of the aircraft with said vertical velocity vector to generate second results; and
concatenating, using the neural network, said first results and said second results.

20. An ADS-B collision avoidance method according to claim 15, wherein each of said concentric distance-based zone boundaries has an axial cross-section that is circular.
